(19) United States
(12) Patent Application Publication
(10) Pub. No.: US 2022/0207995 A1
(43) Pub. Date: Jun. 30, 2022

(54) ORIGINATION DESTINATION ROUTE ANALYTICS OF ROAD LANES

(71) Applicant: HERE Global B.V., Eindhoven (NL)

(72) Inventor: James Adeyemi Fowe, Chicago, IL (US)

(21) Appl. No.: 17/537,131

(22) Filed: Nov. 29, 2021

Related U.S. Application Data
(60) Provisional application No. 63/132,108, filed on Dec. 30, 2020.

(51) Int. Cl. G08G 1/01; G06F 16/29

(52) U.S. Cl. CPC G08G 1/0133; G08G 1/0112; G06F 16/29; G08G 1/0145; G08G 1/0141

(57) ABSTRACT

System and methods for determining the prevalence of certain lanes (or popular lanes) that vehicles that traverse origin-destination (OD) routes take. Probe data is acquired from multiple vehicles that traverse a specific lane. The routes of the vehicles are analyzed to identify both intermediate and final origins and destinations. The analysis provides an understanding of which lanes are used for different purposes.

### CROSS REFERENCE TO RELATED APPLICATIONS

This application claims the benefit of the filing date under 35 U.S.C. § 119(e) of Provisional U.S. Patent Application Ser. No. 63/132,108, filed on Dec. 30, 2020, which is hereby incorporated by reference in its entirety.

### FIELD

The following disclosure relates to navigation devices or services.

### BACKGROUND

Origin-destination (OD) studies are often used in transportation planning to determine the travel patterns of vehicles and goods in a particular area. Given the travel patterns, the impacts of alternative solutions to current and future transportation problems can be evaluated. OD estimation requires time- and location-stamped data from which individual movement patterns can be inferred. Aside from traditional data sources such as household travel surveys and license plate surveys, an increasing list of datasets has emerged due to the prevalence of devices and services that can now provide information on when and where a user is.

OD data may be used by Intelligent Transportation Systems (ITS) in the aspect of route analytics at link-level. To take smart city analytics to a higher granularity, there is need to understand vehicle routing behavior at lane-level.

### SUMMARY

In an embodiment, a method is provided for lane level origin destination analysis, the method including acquiring a plurality of probe data from a plurality of probe apparatuses traversing a roadway; map matching each of the probe data to respective lanes of respective links using a lane level map matcher; selecting first vehicle routes that traversed a first lane on a first link during a first time period; determining first origins and first destinations for each of the first vehicle routes; identifying a prevalence of the first origins and first destinations; and generating a visualization of the prevalence of the first origins and first destinations.

In an embodiment, a system for lane level origin destination analysis is provide including a geographic database and a mapping server. The geographic database is configured to store a plurality of probe data from a plurality of probe apparatuses traversing a roadway. The mapping server is configured to: map match each of the probe data to respective lanes of respective links using a lane level map matcher; select first vehicle routes that traversed a first lane on a first link during a first time period; determine first origins and first destinations for each of the first vehicle routes; identify a prevalence of the first origins and first destinations; and generate a visualization of the prevalence of the first origins and first destinations.

In an embodiment, an apparatus provided for lane level origin destination analysis. The apparatus includes at least one processor and at least one memory including computer program code for one or more programs; the at least one memory configured to store the computer program code configured to, with the at least one processor, cause the at least one processor to: acquire a plurality of probe data from a plurality of probe apparatuses traversing a roadway; map match each of the probe data to respective lanes of respective links using a lane level map matcher; select first vehicle routes that traversed a first lane on a first link during a first time period; determine first origins and first destinations for each of the first vehicle routes; identify a prevalence of the first origins and first destinations; and generate a visualization of the prevalence of the first origins and first destinations.

### BRIEF DESCRIPTION OF THE DRAWINGS

Exemplary embodiments of the present invention are described herein with reference to the following drawings.

FIG. 1 depicts an example system for lane level origin destination prevalence according to an embodiment.

FIG. 2 depicts an example region of a geographic database.

FIG. 3 depicts an example geographic database of FIG. 1.

FIG. 4 depicts an example structure of the geographic database.

FIG. 5 depicts an example workflow for lane level origin destination prevalence according to an embodiment.

FIG. 6 depicts an example route that passes through a specific lane.

FIG. 7 depicts an example of routes that traverse a specific lane.

FIG. 8 depicts an example of routes that traverse a second lane of the road segment of FIG. 7.

FIG. 9 depicts an example of a visualization of OD lane level analytics according to an embodiment.

FIG. 10 depicts an example of a visualization of OD lane level analytics according to an embodiment.

FIG. 11 depicts an example of a lane level routing graph according to an embodiment.

FIG. 12 depicts an example device of the system of FIG. 1.

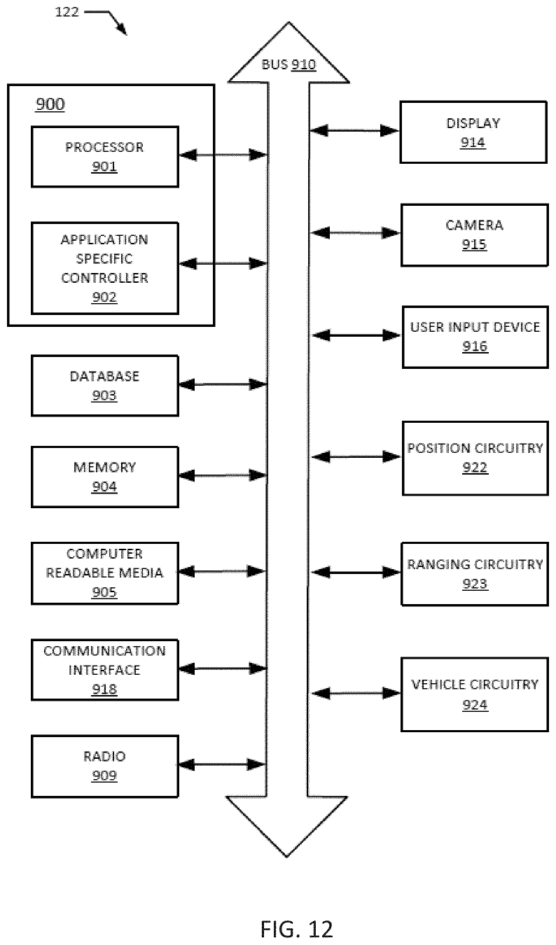

FIG. 13 depicts an example autonomous vehicle according to an embodiment.

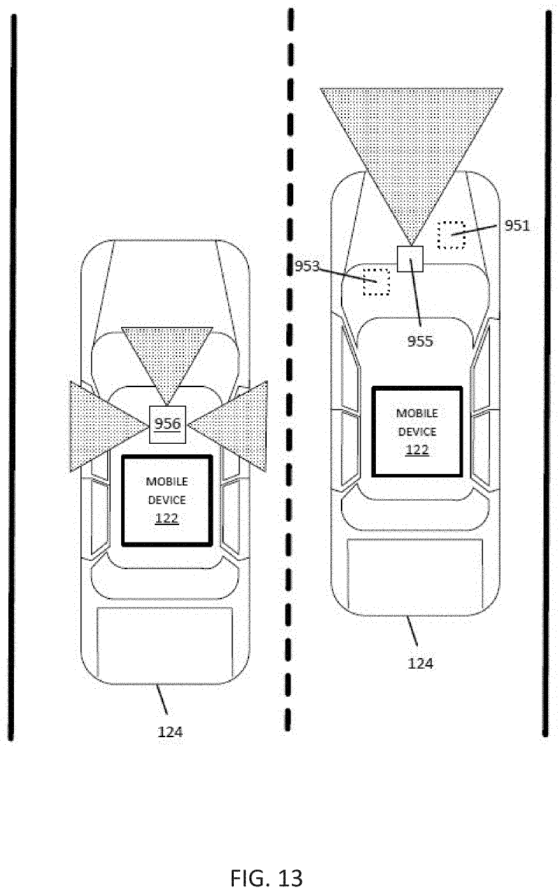

### DETAILED DESCRIPTION

Embodiments described herein provide systems and methods for determining the prevalence of certain lanes (or popular lanes) that vehicles that traverse origin-destination (OD) routes take. Probe data is acquired from multiple vehicles that traverse a specific lane. The routes of the vehicles are analyzed to identify both intermediate and final origins and destinations. The analysis provides an understanding of which lanes are used for different purposes. Lane level OD analysis takes the understanding of the lane of a road beyond the physical infrastructure or neighboring roads/links by analyzing the downstream and upstream affects. The OD data for specific lanes allows intelligent traffic systems to understand the big picture impact that each lane has on the roadway network as a whole.

One problem with existing transportation systems is that roads and its lanes are getting more sophisticated than before due to the rise of multi-modal transportation systems in which there is increase in the need to have dedicated bike-lanes, bus-lanes, scooter-lanes, delivery robots, etc. A challenge for city and transportation planners have is how to know the impact of the changes they make to lanes, for example when reducing or increasing a number of lanes, removing temporarily a lane, or changing a lane to a different transportation mode. The ability to know the expanded city-wide impact on routes or ODs is very important to key decision making. In addition, identifying the use of specific lanes and being able to distinguish one lane from another in its ultimate purpose in transporting people and goods from one location to another can be useful in planning, advertising, and otherwise serving both passengers and other entities on the roadway.

Systems and methods are provided herein that use probe data from a plurality of vehicles to do lane-level analytics in terms of where vehicles come from (upstream OD analytics) and where they go (downstream OD analytics). The lane-level analytics provide an understanding of both the microscopic (intermediate OD along route) and macroscopic OD (covering longer distances or original start and end of journey). The analysis may be used to anticipate present and future traffic patterns, for example the demand to be placed on each lane in the future. The analysis may also be used to determine the usage of lanes during trips into, within, and through an area; and in certain embodiments, the time of day, mode of travel and number of occupants in a vehicle during a trip, the present travel patterns; areas that generate the most traffic; and efficiency of traffic lanes concerning flow and safety, an evaluation of the general road plan and present or foreseeable problems, a determination of a need for revised flow patterns, alternate routes, new streets and parking areas, help determining parking patterns in major functional areas of the installation, and a determination of future travel patterns by being aware of future projects or changes. By anticipating changes, potential traffic problems can be avoided. This might include changes in population, new residential areas, or service facilities.

The following embodiments relate to several technological fields including but not limited to navigation, autonomous driving, assisted driving, traffic applications, and other location-based systems. The following embodiments achieve advantages in these technologies because an increase in the accuracy of the identification of the role that specific lanes play in the operation of the roadway improves the effectiveness, efficiency, and speed of specific application in these technologies. In each of the technologies of navigation, autonomous driving, assisted driving, traffic applications, and other location-based systems, improved understanding of the lane use improves the technical performance of the application. In addition, users of navigation, autonomous driving, assisted driving, traffic applications, and other location-based systems are more willing to adopt these systems given the technological advances that provide smoother and more efficient travel options.

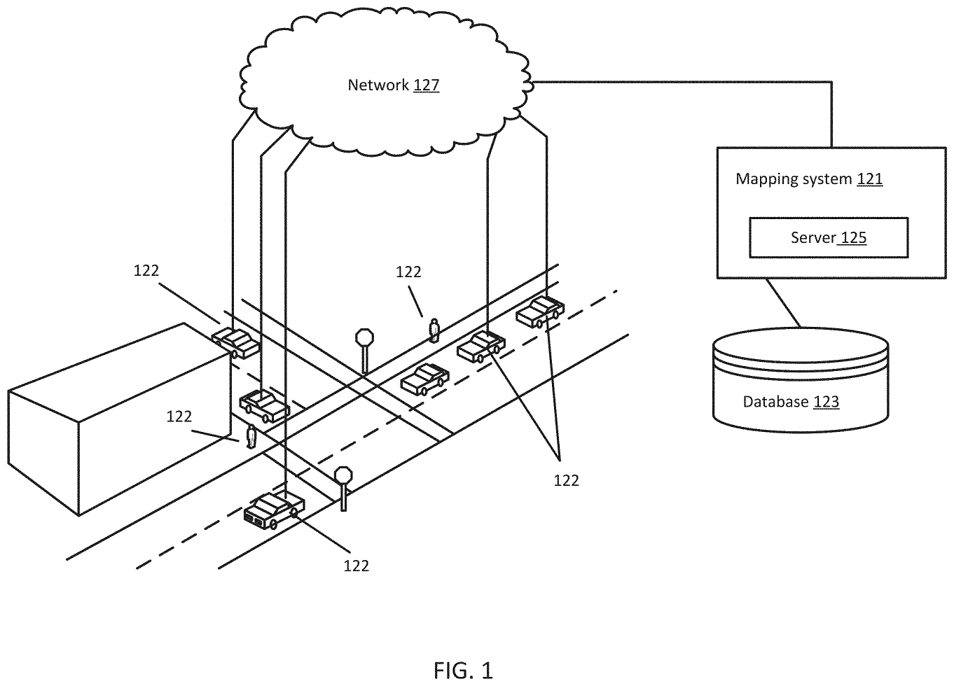

FIG. 1 illustrates an example intelligent traffic system for lane level OD analytics. The intelligent traffic system includes one or more devices 122, a network 127, and a mapping system 121. The mapping system 121 may include a database 123 (also referred to as a geographic database 123 or map database) and a server 125. Additional, different, or fewer components may be included. In an embodiment, the one or more devices collect data that is transmitted to the mapping system 121 over the network 127. The geographic database 123 stores the data. The server 125 processes and analyzes the data. The server 125 makes the processed data available for use by the devices 122 or mapping system 121 to improve the intelligent traffic system.

The one or more devices 122 may also include probe devices 122, probe sensors, IoT (internet of things) devices 122, or other devices 122 such as personal navigation devices 122 or connected vehicles. The device 122 may be a mobile device or a tracking device that provides samples of data for the location of a person or vehicle. The devices 122 may include mobile phones running specialized applications that collect location data as the devices 122 are carried by persons or things traveling a roadway system. The one or more devices 122 may include traditionally dumb or non-networked physical devices and everyday objects that have been embedded with one or more sensors or data collection applications and are configured to communicate over a network 127 such as the internet. The devices 122 may be configured as data sources that are configured to acquire roadway data. These devices 122 may be remotely monitored and controlled. The devices 122 may be part of an environment in which each device 122 communicates with other related devices in the environment to automate tasks. The devices 122 may communicate sensor data to users, businesses, and, for example, the mapping system 121.

One or more of the devices 122 are configured to provide probe reports to the mapping system 121 while traversing a roadway network. Each vehicle and/or mobile device 122 may include position circuitry such as one or more processors or circuits for generating probe data. The probe data may be generated by receiving Global Navigation Satellite System (GNSS) signals and comparing the GNSS signals to a clock to determine the absolute or relative position of the vehicle and/or mobile device 122. The probe data may be generated using embedded sensors or other data relating to the environment of a vehicle or device 122. The probe data may include a geographic location such as a longitude value and a latitude value. In addition, the probe data may include a height or altitude. The probe data may be collected over time and include timestamps. In some examples, the probe data is collected at a predetermined time interval (e.g., every second, ever 100 milliseconds, or another interval). The probe data may also describe the speed, or velocity, of the mobile device 122. The speed may be determined from the changes of position over a time span calculated from the difference in respective timestamps. The time span may be the predetermined time interval, that is, sequential probe data may be used.

In some examples, the probe data is collected in response to movement by the device 122 (i.e., the probe reports location information when the device 122 moves a threshold distance). The predetermined time interval for generating the probe data may be specified by an application or by the user. The interval for providing the probe data from the mobile device 122 to the server 125 may be may the same or different than the interval for collecting the probe data. The interval may be specified by an application or by the user.

The probe data is received by the server 125 or the mapping system 121 and stored in the geographic database 123. The probe data may be analyzed, sorted, adjusted, and filtered prior to storing. The geographic database 123 and a high-definition map are maintained and updated by the mapping system 121 using the probe data and other information. The mapping system 121 may be configured to acquire and process data relating to roadway or vehicle conditions. For example, the mapping system 121 may receive and input data such as vehicle data, user data, weather data, road condition data, road works data, traffic feeds, etc. The data may be historical, real-time, or predictive. The mapping system 121 may include multiple servers, workstations, databases, and other machines connected together and maintained by a map developer. Each server 125 may be configured to perform a different task or alternatively to perform multiple applications.

The server 125 may be a host for a website or web service such as a mapping service and/or a navigation service. The mapping service may provide standard maps or HD maps generated from the geographic data of the database 123, and the navigation service may generate routing or other directions from the geographic data of the database 123. The mapping service also provides information generated from probe data provided by the devices 122. For example, the server 125 may provide OD lane level analytics. The analysis and data may be used by the devices 122 or other entities. The server 125 may provide historical, future, recent or current traffic conditions for the links, segments, paths, or routes using historical, recent, or real time collected data. The server 125 is configured to communicate with the devices 122 through the network 127. The server 125 is configured to receive a request from a device 122 for a route or maneuver instructions and generate one or more potential routes or instructions using data stored in the geographic database 123. The server 125 may broadcast data, publish data, respond to specific requests, or otherwise make data available to other services, applications, or users.

The server 125 is configured to acquire data from the geographic database 123 and perform lane level OD analytics. The data in the geographic database 123 may be acquired by multiple devices 122 over different periods of time. In an embodiment, the probe data may be used to generate routes that a device or vehicle has taken, including an origin, destination, and in most cases one or more waypoint or intermediate locations. Intermediate locations may be waypoints, nodes, or points of interest between a starting point and end point. A route by a vehicle or device 122 may traverse multiple different segments, lanes, nodes, etc. For example, a vehicle traverses the nodes A-B-C-D-E-F-G in sequential order. A is therefore the starting point/origin. G is the ending point/destination. For the intermediate route B-E, B and E are the respective intermediate origin and destination. Thus, a determined route may include multiple intermediate routes for which OD analysis may be performed. In an embodiment, a lane level map matcher is used to map match the probe data to specific lanes on a specific link or segment. The lane level map matching may be performed by the device 122, the server 125, or the mapping system 121. The lane data may be included in each probe report and stored in the geographic database 123. Alternatively, the lane level map matching may be performed by the server 125 after receiving the probe data. The lane information may be stored in the geographic database 123 or otherwise in a memory coupled to the server 125.

The server 125 acquires or accesses the generated routes including which lanes were used by the devices 122 for each route. The server 125 is configured to identify routes that used a specific lane. As an example, for a time period of 15 minutes, there may be 10's or 100's of vehicles that used a lane. The server 125 identifies the routes of each of these vehicles (if possible). The server 125 is configured to identify popular or prevalent origins and destinations for the routes that used a particular lane. The server 125 is also configured to identify popular, similar, or prevalent clusters of origins and destinations for each specific lane of each specific link. Clusters may be neighborhoods, city locations, point of interests, general regions, or quadkeys. A quadkey is an identifier for an area that subdivides the Mercator projected flat world map into quadrants.

In an example, during a specific time period (for example, a 5-minute window, 10-minute window, an hour, etc.) a number of vehicles traversed a specific lane of a specific link in a roadway network. The server 125 is configured to identify where each of these vehicles began their journey, intermediate links and lanes along the way to the specific lane, intermediate links and lanes after the specific lane, and different destinations. The server 125 may also be able to identify purposes of each trip/route, for example, going to work, going to home, going shopping, etc. The server 125 may use this data to identify the prevalent use of a specific lane for similar time periods. Using this example, the server 125 may be configured to predict the purpose of a trip or destination by identifying, in real time, that a vehicle is using the specific lane. The server 125 may use historical data for different time periods to further analyze the usage of specific lanes. The use of a lane in one time period may have different OD analytics than a different time period. For example, in the morning, a popular origin and destination may be a residential neighborhood and a business district. While in the afternoon a popular origin and destination may be a school or shopping district.

The server 125 is configured to provide route guidance to devices 122 and vehicles. Because lanes are more granular and specific than links, routing and lane level OD analytics may be more beneficial than full link OD analytics. For example, the use of a left-hand turn lanes may result in very different destinations than an adjacent lane. Vehicles that use a certain lane may come from a certain neighborhood. Certain lanes may be used more frequently to access certain destinations or points of interest. Routing from an origin to a destination may take into account the prevalence of origins and destinations for certain lanes, for example by identifying potential destinations for vehicles currently on the lane or by measuring traffic flow of a lane to predict downstream traffic flow.

The server 125 is configured to predict routes or maneuvers for devices 122 or vehicles. The server 125 may be configured to identify a vehicle in a lane, using for example, sensors in a vehicle or on the roadside. The server 125 is configured to determine/predict prevalent origins, prevalent destinations, and waypoints in the route of the vehicle based on the identified lane. Using these predictions, the server 125 may adjust or generate traffic flow or traffic density for downstream lanes or links. The server 125 may also be configured to identify that a vehicle traversed several different lanes. The server 125 may be configured to cross reference the popular destinations for each of the lanes to predict, in real time, the destination of the vehicle in question. As an example, an autonomous vehicle may identify that another vehicle has used one or more lanes. The most popular destination for vehicles that traverse these lanes is the local airport. The autonomous vehicle may then predict that the vehicle is going to the local airport. If the autonomous vehicle is also heading to the airport, the two vehicles may form, for example, a platoon in order to traverse the roadway more safely.

The term autonomous vehicle refers to a self-driving or driverless mode in which no passengers are required to be on board to operate the vehicle. There are five typical levels of autonomous driving. For level 1, individual vehicle controls are automated, such as electronic stability control or automatic braking. For level 2 at least two controls can be automated in unison, such as adaptive cruise control in combination with lane-keeping. For level 3, the driver can fully cede control of all safety-critical functions in certain conditions. The car senses when conditions require the driver to retake control and provides a “sufficiently comfortable transition time” for the driver to do so. For level 4, the vehicle performs all safety-critical functions for the entire trip, with the driver not expected to control the vehicle at any time. For level 5, the vehicle includes humans only as passengers, no human interaction is needed or possible. Vehicles classified under Levels 4 and 5 are considered highly and fully autonomous respectively as they can engage in all the driving tasks without human intervention. An autonomous vehicle may also be referred to as a robot vehicle or an automated vehicle. As defined, the autonomous vehicle may include passengers, but no driver is necessary. The autonomous vehicles may park themselves or move cargo or passengers between locations without a human operator. Autonomous vehicles may include multiple modes and transition between the modes.

The server 125 may be configured to provide advertisements or entertainment options to devices 122 based on the expected origin, route, or destination. The advertisements or entertainment may be located on the side of the road, for example as an electronic billboard. The server 125 may be configured to provide information to the operator of the advertising that indicates for different time periods the OD analytics for a specific lane that is related to the advertisement. As an example, an advertisement may be directed to certain places of businesses because the advertisement is related to lane whose origins and destinations are related to the certain places of businesses.

The server 125 is configured to assist planners. Planner may use the lane level OD to identify the potential result of closing or adjusting a lane. As an example, using OD lane level analysis, a city planner may be able to identify that a certain destination may be affected differently when closing one lane or another. Different populations may use different lanes differently. This data may be used to proactively adjust traffic planning to avoid issues.

To communicate with the devices 122, systems or services, the server 125 is connected to the network 127. The server 125 may receive or transmit data through the network 127. The server 125 may also transmit paths, routes, or risk data through the network 127. The server 125 may also be connected to an OEM cloud that may be used to provide mapping services to vehicles via the OEM cloud or directly by the server 125 through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols. The devices 122 and vehicles may use Vehicle-to-vehicle (V2V) communication to wirelessly exchange information about their speed, location, heading, and roadway conditions with other vehicles, devices 122, or the mapping system 121. The devices 122 may use V2V communication to broadcast and receive omni-directional messages creating a 360-degree “awareness” of other vehicles in proximity of the vehicle. Vehicles equipped with appropriate software may use the messages from surrounding vehicles to determine potential threats or obstacles as the threats develop. The devices 122 may use a V2V communication system such as a Vehicular ad-hoc Network (VANET).

The HD map and the geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Remote sensing, such as aerial or satellite photography, may be used. The database 123 is connected to the server 125. The geographic database 123 and the data stored within the geographic database 123 may be licensed or delivered on-demand. Other navigational services or traffic server providers may access the traffic data stored in the geographic database 123. Data for an object or point of interest may be broadcast as a service.

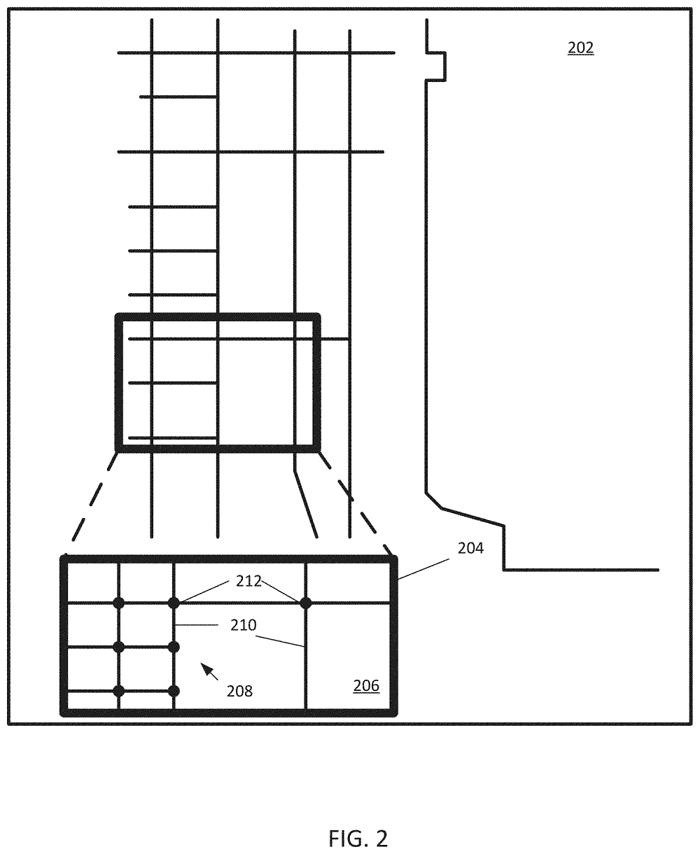

Information about the roadway, links, lanes, origins, destinations, and other information is stored in a geographic database 123. The geographic database 123 includes information about one or more geographic regions. FIG. 2 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 2 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

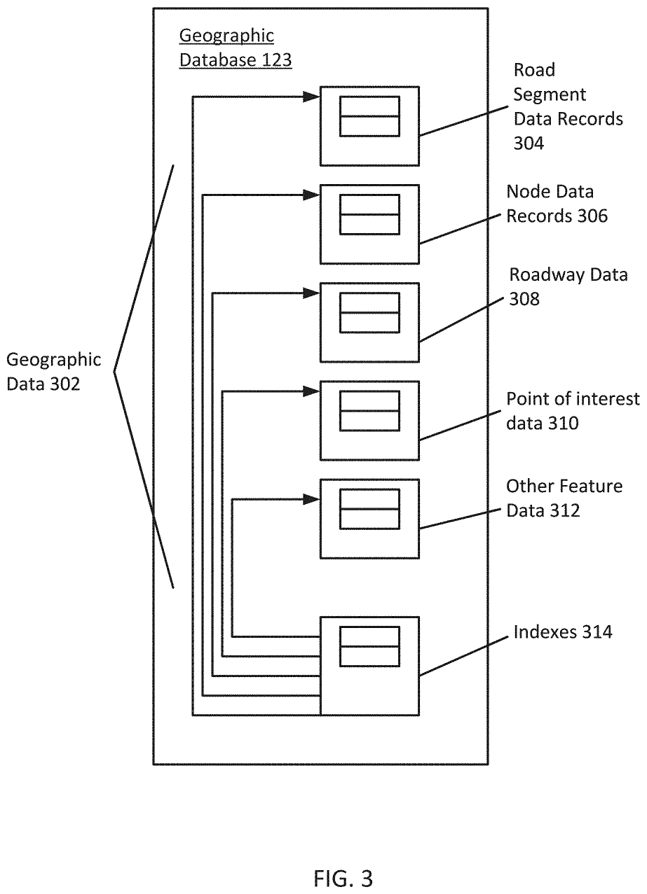

As depicted in FIG. 3, in one embodiment, the geographic database 123 contains geographic data 302 that represents some of the geographic features in the geographic region 202 depicted in FIG. 2. The data 302 contained in the geographic database 123 may include data that represent the road network 208. In FIG. 3, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges etc. The roadway data 308 may be further stored in sub-indices that account for different types of roads or features. The point of interest data 310 may include data or sub-indices or layers for different types points of interest. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The feature data 312 may include other roadway features. The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

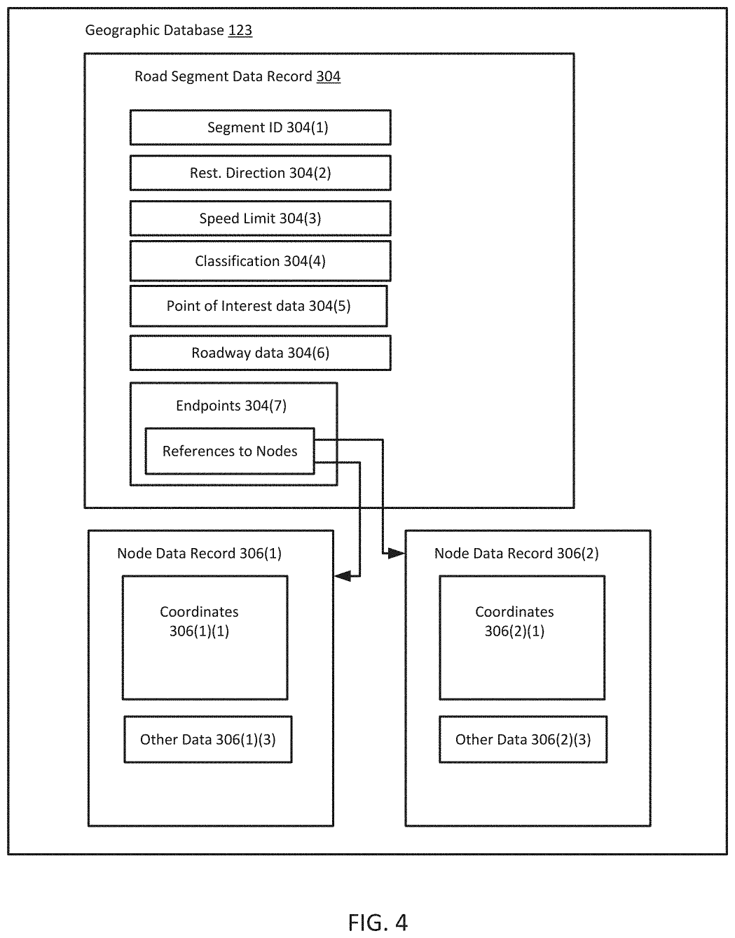

FIG. 4 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with the data record, information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes roadway data. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, among others. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is known, the street address ranges along the represented road segment, and so on.

The road segment data record 304 includes data related to OD prevalence for each lane calculated by the server. The OD prevalence may indicate the occurrence that a vehicle ends up at a destination or starts at an origin for different time periods or events. The OD prevalence data may include both microscopic (intermediate) and macroscopic (starting point/ending point) data. The OD prevalence data may, for example, include the most popular intermediate lane or segment after the vehicle traverses the lane or the most popular intermediate lane or segment prior to the vehicle traversing the lane. In addition, the OD prevalence data includes data relating to the prevalence to the starting point and final destination of each of the vehicles that traversed the specific lane. Table 1 below describes how each entry may be stored.

TABLE 1

| | | | Top | Top | |
|---|---|---|---|---|---|
| | | Time | Upstream | Downstream | Top |
| Link- | Lane | (Week- | Quadkeys/ | Quadkeys/ | Quadkeys/ |
| ID | Number | epoch) | Links | Links | Links |
| 71716 | 1 | 15 mins | 1345 (22%), | Selected based | Selected based |
| | | week | 1345 (21%), | on Qd count | on (Qu + Qd) |
| | | epoch | 1347 (8%) | | count |

In Table 1, there is an entry for each lane of each link. Lane may have multiple entries for different times (here described as week-epoch). The table lists the top upstream quadkey, the top downstream quadkey, and the top quadkey overall. By accessing this data, a user or application may be able to quickly determine the most likely destination for a vehicle that is current on the lane and the most likely origin.

FIG. 4 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 4, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes.

The data in in the geographic database 123 may also be organized using a graph that specifies relationships between entities. A Location Graph is a graph that includes relationships between location objects in a variety of ways. Objects and their relationships may be described using a set of labels. Objects may be referred to as “nodes” of the Location Graph, where the nodes and relationships among nodes may have data attributes. The organization of the Location Graph may be defined by a data scheme that defines the structure of the data. The organization of the nodes and relationships may be stored in an Ontology which defines a set of concepts where the focus is on the meaning and shared understanding. These descriptions permit mapping of concepts from one domain to another. The Ontology is modeled in a formal knowledge representation language which supports inferencing and is readily available from both open-source and proprietary tools.

Embodiments provide a big picture view of the influence of a specific lane of a road segment on the bigger roadway network by analyzing where vehicles come from and where they go at different times of the day. Having this insight helps planners and other entities to understand the fundamental and complete role or how critical a lane of a road is to the roadway network. Roadworks planning that will lead to lane-closure, city planners can visualize which region of the city or routes will be impacted the most. Embodiments also provide granular location-based advertisement, in which display advertisement tune their ads based on the areas of the city where people who traverse that lane of the road are coming from or going to. Outdoor display ads can do special ads targeting to vehicles driving on some lanes given that the upstream OD and downstream OD data is known. In-car advertising may also be more targeted by using not just the knowledge of the current lane the vehicle is driving on, the potential downstream route, but also the most likely region of the city the driver is driving to. In certain embodiment, predict routing may be provided using the OD lane analytics data to obtain lane-level turn/maneuver probabilities.

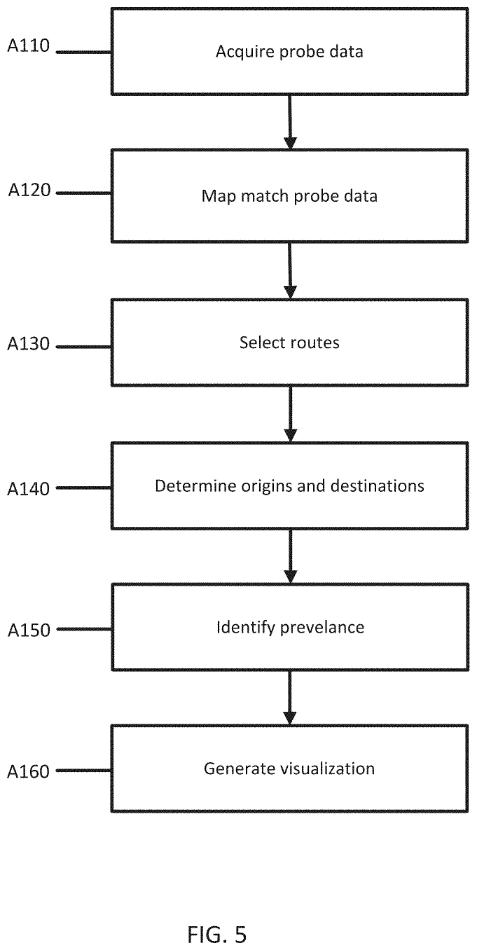

FIG. 5 depicts an example workflow for lane level origin destination analytics. As presented in the following sections, the acts may be performed using any combination of the components indicated in FIG. 1, 12, or 13. The following acts may be performed by the server 125, the device 122, the mapping system 121, or a combination thereof. As an example, a copy of the geographic database 123 may be updated on the device 122 from the mapping system 121. A vehicle, for example an autonomous vehicle may take instructions or be provided information from either the device 122 or the mapping system 121 based on data stored in the geographic database 123. In certain situations, the device 122 may be used as there is little to no delay for instructions to be generated and transmitted from the device 122 to the vehicle. The server 125 of the mapping system 121 may collect data from multiple devices 122 and provide this data to each of the devices 122 so that the devices and vehicles are able to provide accurate instructions. Additional, different, or fewer acts may be provided. The acts are performed in the order shown or other orders. The acts may also be repeated. Certain acts may be skipped.

At act A110, the server 125 acquires a plurality of probe data from a plurality of vehicles traversing a roadway. The probe data may be stored in a geographic database 123. Each of the probe data may be received from a probe apparatus of a plurality of probe apparatuses, each probe apparatus traveling between a respective origin and destination pair, each probe apparatus comprising one or more sensors and being onboard a respective vehicle, wherein each probe data comprises location information associated with the respective probe apparatus. The probe data (e.g., collected by mobile device 122) is representative of the location of a vehicle at a respective point in time and may be collected while a vehicle is traveling along a route. While probe data is described herein as being vehicle probe data, example embodiments may be implemented with pedestrian probe data, marine vehicle probe data, or non-motorized vehicle probe data (e.g., from bicycles, skateboards, horseback, etc.). According to an embodiment described below with the probe data being from motorized vehicles traveling along roadways, the probe data may include, without limitation, location data, (e.g. a latitudinal, longitudinal position, and/or height, GPS coordinates, proximity readings associated with a radio frequency identification (RFID) tag, or the like), a lane identification, a rate of travel, (e.g. speed), direction of travel, (e.g. heading, cardinal direction, or the like), device identifier, (e.g. vehicle identifier, user identifier, or the like), a time stamp associated with the data collection, or the like. The mobile device 122, may be any device capable of collecting the aforementioned probe data. Some examples of the mobile device 122 may include specialized vehicle mapping equipment, navigational systems, mobile devices, such as phones or personal data assistants, or the like.

At act A120, a lane level map matcher is applied to probe data from each vehicle in order to obtain a series of links and lanes that the vehicle/device 122 traversed in sequence. In certain embodiments, the lane level map matching may be performed by the device 122 wherein the lane identifier or information may be included with the probe data. Alternatively, the lane which the device 122 was traversing may be identified after the fact by the server 125 or mapping system 121 from information included with the probe device. The lane level map matcher a route from an origin to a destination for each of the respective vehicles. A subset of contiguous links on the routes that are common to vehicles are grouped per origin and destination of the subset, providing a broader database of origins and destinations that actual address locations of origins and destinations where specific vehicles start and end their respective routes. A lane-level map matcher may be run on each trajectory or vehicle path traveled in order to obtain the lane each vehicle traveled in along their route. This provides a path of the respective vehicles within the plurality of lanes along road segments of the routes having a plurality of lanes. A distance metric may be used that separates each trajectory, where the distance metric is a function of lane center distances from a centerline of the road segment and may be a measure from a road segment centerline to a vehicle path, thus identifying the lane of the vehicle. The distance metric may be used in a K-medoid clustering algorithm to obtain K clusters or most popular sequence of vehicle maneuver strategies along the road segments. The distance metric may be a summation of lane number difference over total links on the path of the vehicle. The medoid (center) of the clusters may represent the most popular lane maneuver as represented by the center of the cluster for each cluster.

Alternative lane level map matching techniques may be used. In an embodiment, a GPS value may be used to identify the road segment using a map matching algorithm to match the GPS coordinates to a stored map and road segment. Lane level map mapping techniques may be used to identify the lane, for example, from the GPS data or additional sensor data included with the probe data. The probe data may be collected at a high enough spatial resolution to distinguish between lanes of the roadway. As another example, lane level map matching may provide a good estimate of what lane a vehicle is on given a sequence of GPS probes coming from the vehicle. Sensor data such as lateral acceleration sensors may be used to identify a lane. Lane changes may be detected by determining a threshold of acceleration x time, above which a lane change would have occurred. The method may only detect that the change was of sufficient magnitude and direction to have a displacement greater than the lane width. Gyro compasses, gyro-like compasses or magnetometers of sufficient sensitivity may also be used to indicate if the vehicle is or is not turning onto another road. For example, a value would be less than a 45-degree total change without a road curvature. Another method may use lateral acceleration method indicating initiation of a lane change, followed by lateral deceleration without a large change in direction to indicate completion of the lateral displacement. A determination of intent or completion of a lane change may be determined using individual techniques or a combination of multiple techniques. The probe report may include data from multiple sensors from which a lane change maneuver may be derived. For lane level map matching, using historical raw GPS probe positions, a layer of abstraction may be created over a map which is used to generate lane probabilities of real-time probes based on their lateral position. The probabilities form emissions probabilities of a hidden Markov model in which a Viterbi algorithm is used to make an inference of the actual most probable lane a probe trajectory traversed.

In another example, the lanes may be distinguished through another type of positioning. For example, the lane level map matcher or device 122 may analyze image data from a camera or distance data from a distancing system such as light detection and ranging (LiDAR). The lane level map matcher or device 122 access a fingerprint or other template to compare with the image data or the distance data. Based on the comparison, the lane level map matcher or device 122 determines the location of the device 122, and based on the boundaries of the lanes, determines the lane of travel of the mobile device 122. In another example, the device 122 detects lane lines. The lane lines may be detected from the camera data or distance data. Images of the road surface may be analyzed by the device 122 to identify patterns corresponding to lane lines that mark the edges of the lanes. Similarly, distance data such as LiDAR may include the location of lane markers.

In another example, the device 122 performs triangulation to determine the lane of travel of the device 122. Triangulation may involve comparison of the angle, signal strength, or other characteristics of wireless radio signals received from one or more other devices. The positioning may be based on a received signal strength indicator (RSSI) measured at the mobile device 122. The RSSI may decrease proportionally to the square of the distance from the source of the signal. The positioning technique may analyze cellular signals received from multiple towers or cells. Position may be calculated from triangulation of the cellular signals. Several positioning techniques may be specialized for indoor applications such as pseudolites (GPS-like short range beacons), ultra-sound positioning, Bluetooth Low Energy (BTLE) signals (e.g., High-Accuracy Indoor Positioning, HAIP) and WiFi-Fingerprinting.

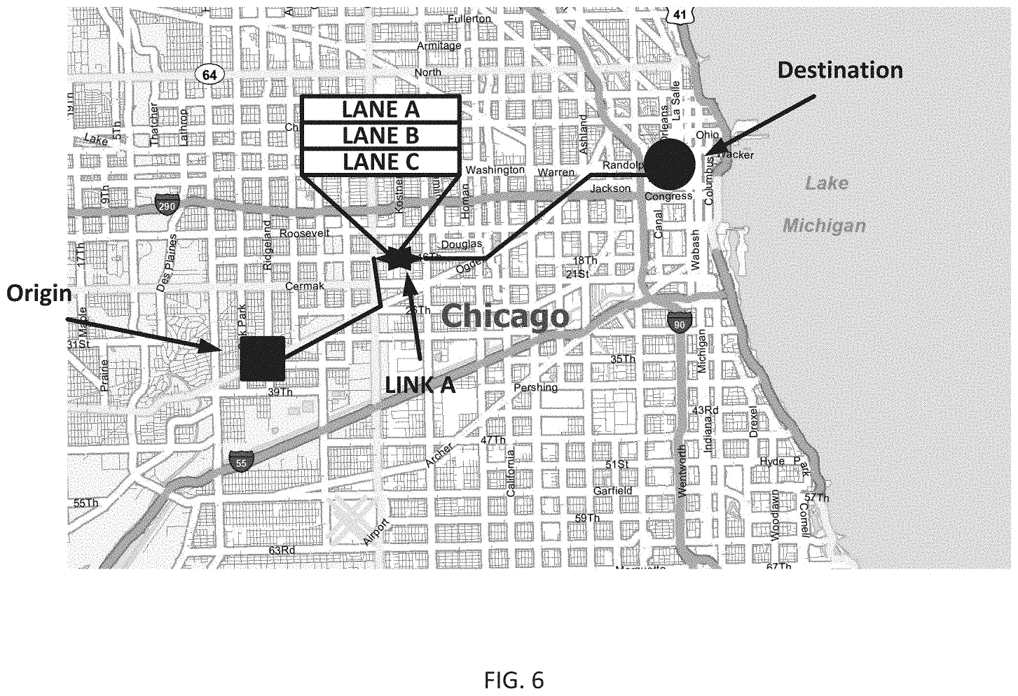

The result of the lane level map matching is a route for each of the vehicles that provided probe data, the route including lane level positioning. FIG. 6 depicts an example of a single route that traverses a specific lane. The route begins at the square and ends at the circle. The route uses the first link and more specifically, Lane A of the first link. As the vehicle traverses the route, probe data is acquired. The probe data is map matched using a lane level map matcher to specific lanes for each link that the vehicle traverses.

At act A130, the server 125 selects routes that traversed/include at least a first lane on a first link during a first time period. The time period may be 1 min, 5 min, 10 min, 15 min, 60 min, etc. long. In an embodiment, a day, week, month, or year may be divided into different time periods. For example, each hour of each day of the workweek may be set as a time period (for example, 4 pm Monday, Tuesday, Wednesday, Thursday, Friday). Holidays and other events may be separated out or measured in different buckets. As an example, if there is a unique event (e.g., sporting event) that affects traffic or is predicted to affect traffic, the data for the time period when that event occurs may not be used during normal processing, but rather may be identified as a recurring event which is analyzed on its own or with other similar data. Similarly, weather data may be identified for a particular time period and separated or taken into account as weather may affect traffic patterns or traffic flows.

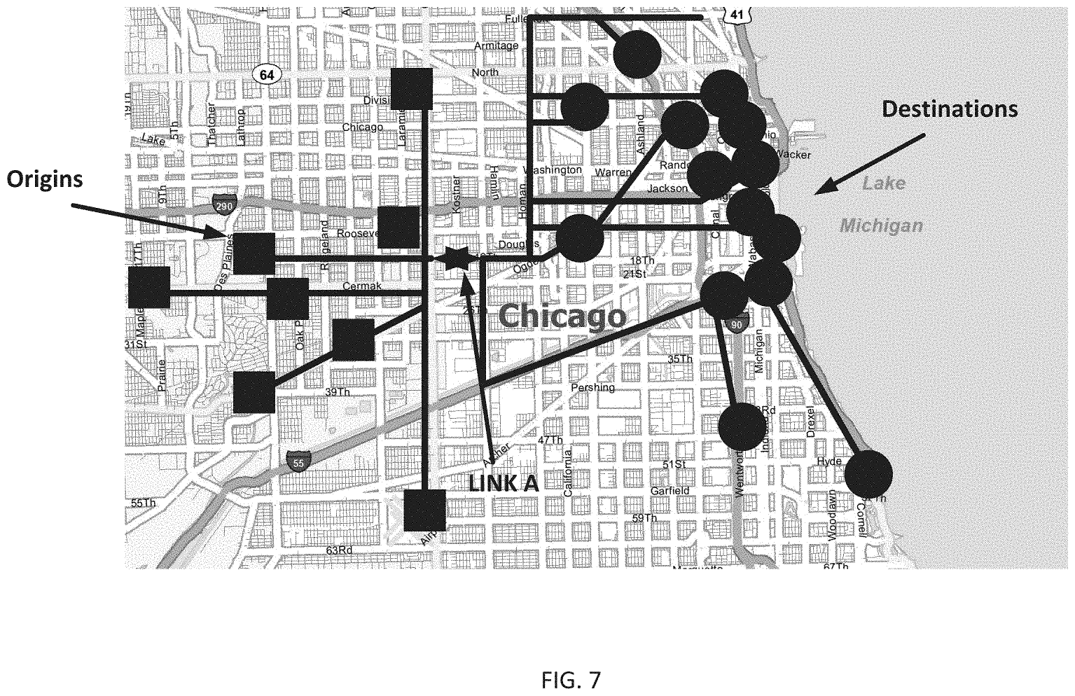

For each timer period there may be 10s, 100s, or thousands of routes that include the at least first lane on the first link during the first time period. FIG. 7 depicts an example of multiple routes that traversed the first lane. The starting points are indicated by squares, the end points indicated by circles. In between the starting points and end points are multiple different waypoints/nodes.

In an embodiment, the server 125 further selects routes that traversed a second lane on the first link during the first time period. Analysis for the second lane may help with identifying unique characteristics of the first lane. In certain scenarios, the OD analytics of the first lane and second lane may provide information that may assist planners in determining which lanes are used for routes to specific destinations. The server 125 may also perform comparisons for the first lane at different time periods or for adjacent lanes or segments.

At act A140, the server determines origins and destination for each of the routes. The origins and destinations may be grouped or clustered based on similar characteristics or location. Location clusters may include for example, residential neighborhoods, business districts, shopping districts, tourist districts, etc. Clusters may be identified manually or automatically. In an example, a city planner may identify particular areas or locations and generate clusters to fit their needs. In another example, the clusters may be generated using quadkeys. A quadkey is a number consisting of digits 0-3 that each subdivide the Mercator projected flat world map into quadrants. Different methods or clusters may be used.

FIG. 7 described above depicts an example of the origins and destinations for routes that traverse Lane A. While the origins are spread out over a wide area, the destinations are grouped in a downtown/business area. A planner may be able to determine that vehicles that use Lane A (during the time period when the data was collected) were primarily driven from various residential neighborhoods to a downtown area. Closing the lane may thus primarily affect the rush hour traffic. In addition, advertisers would benefit from advertising locations or services to vehicles in Lane A that relate to the downtown area or the residential neighborhoods.

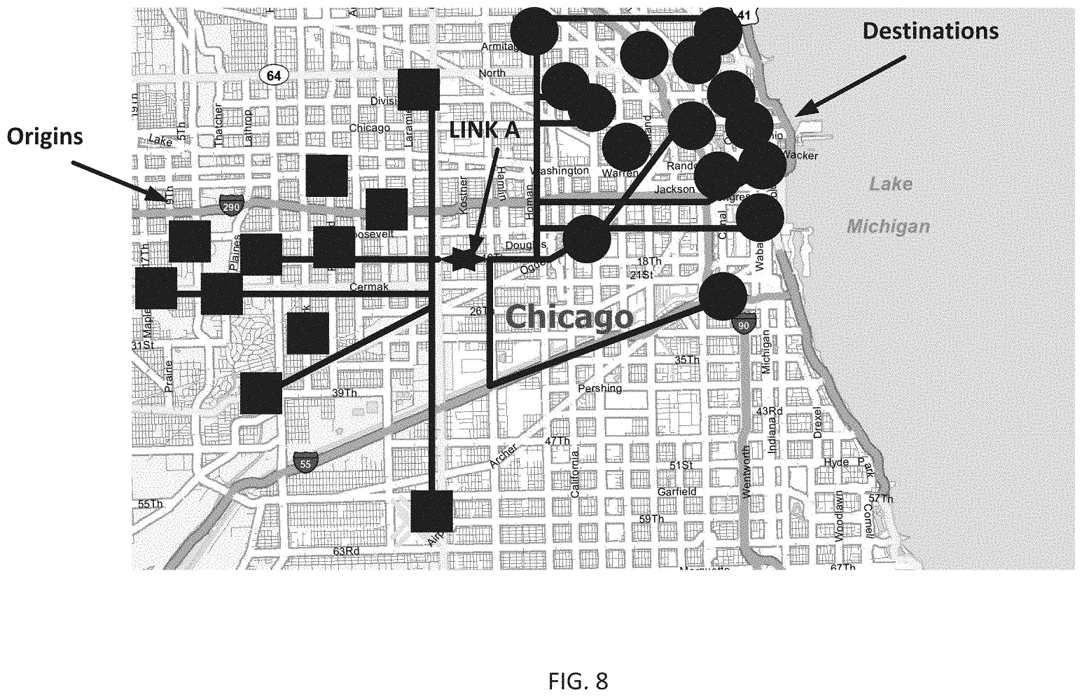

FIG. 8 depicts an example of the origins and destinations for routes that traverse Lane B. As depicted, the origins and destinations for lane A and lane B are slightly different although they share some similar characteristics. Users of Lane B still primarily end up downtown, but few to no vehicles end up south of downtown. The differences between the origins and destinations of Lane A and Lane B may be used when making decisions on new lanes or lane closures or other city planning. In an example, if city planners wanted to close another lane that was also used to access the downtown area, they might predict that both Lane A and Lane B would see increased traffic flow as they are also used to access the downtown area.

At act A150, the server identifies a prevalence of the origins and destinations. The prevalence may be adjusted based on other data, for example weather or certain events. The prevalence is calculated by comparing the number of vehicles that start or end at each respective origin or destination with the total number of routes identified, and may be expressed as a fraction, a percentage, or the number of routes per 100, 10,000, 100,000 etc. At act A160, the server generating a visualization of the prevalence of the origins and destinations. The server may generate different visualizations for different time periods and different lanes. A user may select a lane and time period. The server may provide in, for example, a map view, the prevalence or most popular destinations or clusters.

In an embodiment the prevalence of origins and destinations may be used by city planners for roadworks planning that will lead to lane-closure. With the visualization or prevalence data, the city planners may visualize which region of the city or routes will be impacted the most. In an embodiment, a map may be presented with multiple lanes for multiple links. A user may select a link and a lane. The visualization may provide data or statistics related to the lane level OD, for example, by showing the routes, popular origins, destinations, clusters, etc.

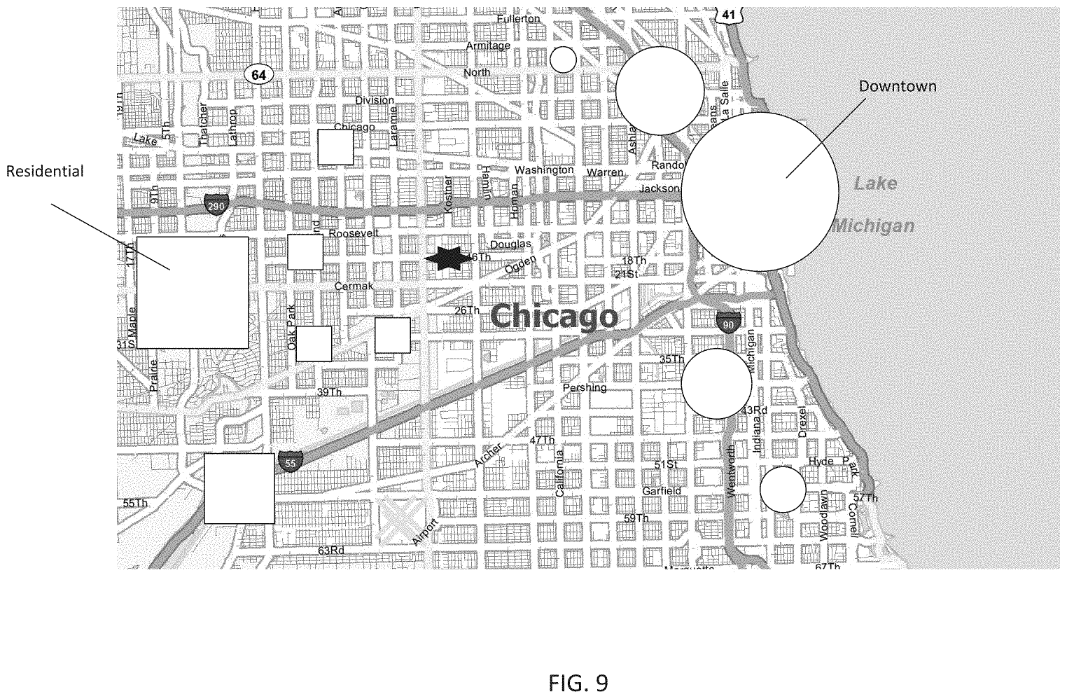

FIG. 9 depicts an example visualization of the origins and destination for routes that make use of Lane A. As depicted, the prevalence of origins and destinations is depicted by the size of the square or circle for each area/cluster. For example, the downtown area includes the largest circle since it is the most popular destination.

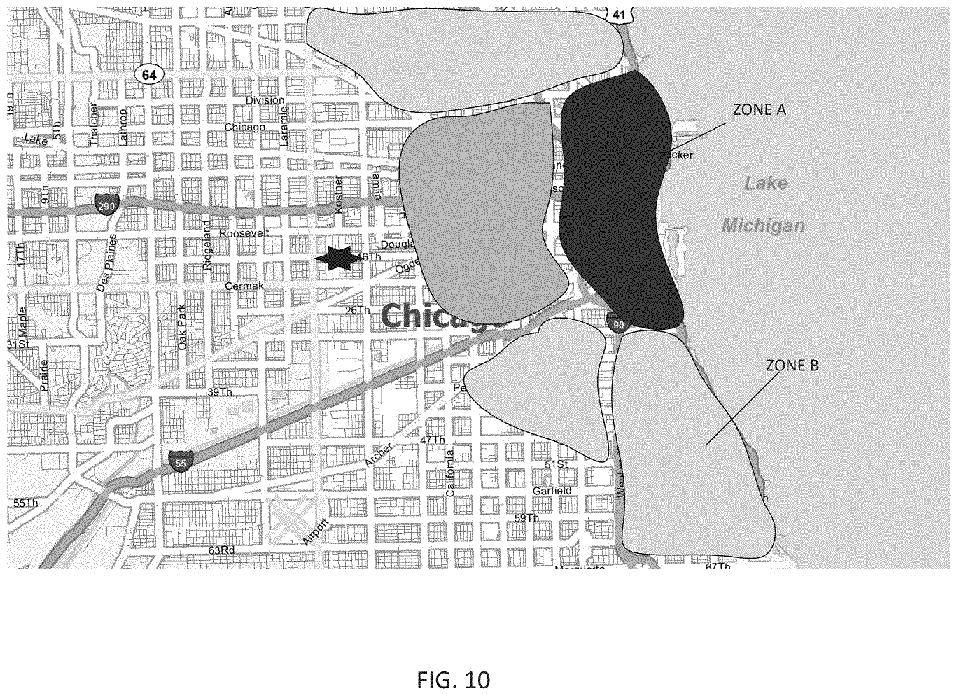

FIG. 10 depicts another example visualization of the destinations for routes that make use of Lane A. In FIG. 10, different areas are identified based on characteristics of the areas. For example, Zone A is shaded very dark because it is the most popular destination. Zone B is shaded with a lighter grey as it is less popular.

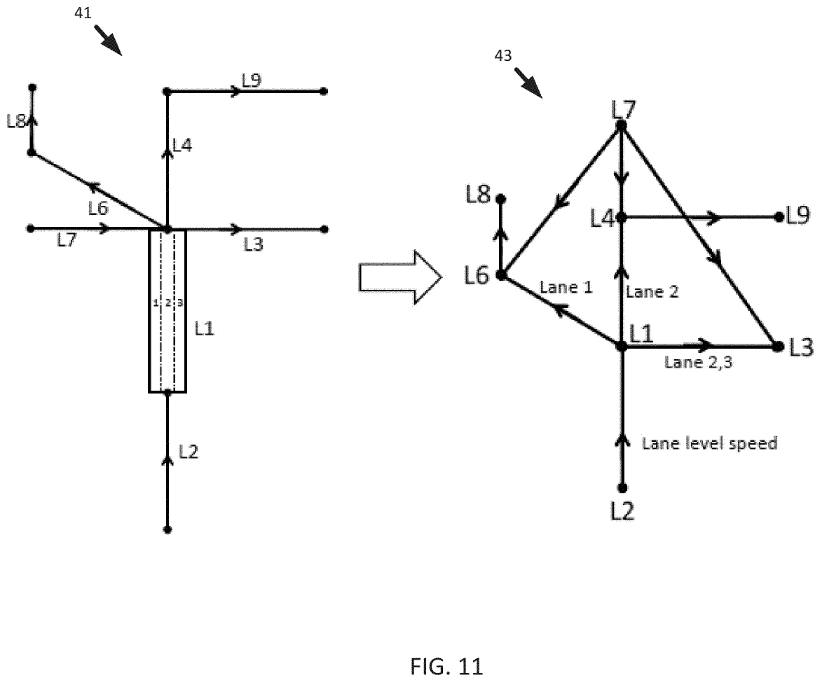

In an embodiment, to understand the influence of a lane on neighboring road lanes, a lane network graph (LNG) illustrated in FIG. 11 may be used. FIG. 11 illustrates an example road network graph conversion from the first road network format 41 to the second road network format 43. The first road network format 41 includes road links L1-L9 and three nodes. Each of the road links L1-L9 is associated with a single direction. Some or all of the road links may be associated with two directions in another example that is not illustrated. At a first node, road link L6 intersection road link L8. At a second node, road link L4 intersection road link L9. At a third node, road links L1, L3, L4, L6, and L7 intersect. The direction of the road links may also impact the road network graph. For example, in the first node traffic flow is from road link L6 to road link L8 and not from road link L8 to road link L6 and in the second node traffic flow is from road link L4 to road link L9 and not from road link L9 to road link L4. In the third node, traffic flows into the node from road links L1 and L7 and out of the node via road links L3, L4, and L6. These directions define the second road network format 43. Each of the links in the first road network format 41 are converted to nodes in the second road network format 43. For example, road link L1 in the first road network format 41 receives traffic from road link L2 and empties traffic into road links L3, L4, and L6. Accordingly, a graph edge in the second road network format extends from the node for L2 to the node for L1 and graph edges extends from the node for L1 to each of the nodes for L3, L4, and L6.

A road link that is downstream to each of the lanes in the multi-lane road link may be identified. For example, for multi-lane road link L1 in FIG. 4, the left lane (lane 1) may provide traffic only to road link L6, the middle lane (lane 2) may provide traffic only to road link L4, and the right lane (lane 3) may provide traffic only to road link L3.

The first road network format 41 includes road links L1-L9 and three nodes. Each of the road links L1-L9 is associated with a single direction. Some or all of the road links may be associated with two directions in another example that is not illustrated. If lane 1 (a dedicated left-turn lane) of link L1 is the lane to be analyzed, it is obvious that on the transformed graph (the lanes edge is removed to illustrate lane closure) that the downstream links to lane 1 are links L6 & L4 and L2 is upstream. Because these links are directly connected, these are called first-order neighbors, whereas the next connected links upstream or downstream are called 2nd-order neighbors, etc. The spatial influence of the lane of a link may be expanded by using the LNG to the nth-order neighbors and be able to obtain upstream and downstream count in the links that are in the nth-order neighbor set at different time t. The upstream and downstream lanes may be identified and visualized.

In an embodiment, outdoor display ads may provide special ads targeting to vehicles driving on some lanes given that the upstream OD and downstream OD data is known. In an embodiment, in-car advertising may be more targeted by using not just the knowledge of the current lane the vehicle is driving on, the potential downstream route, but also the most likely region of the city the driver is driving to. In an embodiment, predictive routing may be provided by using the prevalence data to obtain or predict lane-level turn/maneuver probabilities.

FIG. 9 illustrates an example mobile device 122 for the system of FIG. 1 embedded in or included with a vehicle. The mobile device 122 may include a bus 910 that facilitates communication between a controller 900 that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, ranging circuitry 923, and vehicle circuitry 924. The contents of the database 903 are described with respect to the geographic database 123. The device-side database 903 may be a user database that receives data in portions from the database 903 of the mobile device 122. The communication interface 918 connected to the internet and/or other networks (e.g., network 127 shown in FIG. 1). Additional, different, or fewer components may be included.

The mobile device 122 is configured to acquire probe data while traversing a roadway. The probe data may be generated by receiving GNSS signals and comparing the GNSS signals to a clock to determine the absolute or relative position of the vehicle and/or mobile device 122. The probe data may be generated using embedded sensors or other data relating to the environment of a vehicle or device 122. The probe data may include a geographic location such as a longitude value and a latitude value. In addition, the probe data may include a height or altitude. The probe data may be collected over time and include timestamps. In some examples, the probe data is collected at a predetermined time interval (e.g., every second, ever 100 milliseconds, or another interval). The probe data may also describe the speed, or velocity, of the mobile device 122. The speed may be determined from the changes of position over a time span calculated from the difference in respective timestamps. The time span may be the predetermined time interval, that is, sequential probe data may be used.

The controller 900 may communicate with a vehicle engine control unit (ECU) that operates one or more driving mechanisms (e.g., accelerator, brakes, steering device). Alternatively, the mobile device 122 may be the vehicle ECU, that operates the one or more driving mechanisms directly. The controller 900 may include a routing module including an application specific module or processor that calculates routing between an origin and destination. The routing module is an example means for generating a route. The routing command may be a driving instruction (e.g., turn left, go straight), that may be presented to a driver or passenger, or sent to an assisted driving system. The display 914 is an example means for displaying the routing command. The mobile device 122 may generate a routing instruction based on the anonymized data.

The routing instructions may be provided by the display 914. The mobile device 122 may be configured to execute routing algorithms to determine an optimum route to travel along a road network from an origin location to a destination location in a geographic region. Using input(s) including map matching values from the mapping system 121, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments. The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

The memory 904 may be a volatile memory or a non-volatile memory. The memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122. The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

The ranging circuitry 923 may include a LiDAR system, a RADAR system, a structured light camera system, SONAR, or any device configured to detect the range or distance to objects from the mobile device 122. Radar sends out radio waves that detect objects and gauge their distance and speed in relation to the vehicle in real time. Both short- and long-range radar sensors may be deployed all around the car and each one has their different functions. While short range (24 GHz) radar applications enable blind spot monitoring, for example lane-keeping assistance, and parking aids, the roles of the long range (77 GHz) radar sensors include automatic distance control and brake assistance. Unlike camera sensors, radar systems typically have no trouble when identifying objects during fog or rain. LiDAR (Light Detection and Ranging) sensors work similar to radar systems, with the difference being that LiDAR uses lasers instead of radio waves. Apart from measuring the distances to various objects on the road, the vehicle may use LiDAR to create 3D images of the detected objects and mapping the surroundings. The vehicle may use LiDAR to create a full 360-degree map around the vehicle rather than relying on a narrow field of view.

The ranging circuitry may also include cameras at every angle and may be capable of maintaining a 360° view of its external environment. The vehicle may utilize 3D cameras for displaying highly detailed and realistic images. These image sensors automatically detect objects, classify them, and determine the distances between them and the vehicle. For example, the cameras can easily identify other cars, pedestrians, cyclists, traffic signs and signals, road markings, bridges, and guardrails. Different sensors may be used at different times of the day (because of lighting) or in different locations or during weather events. In additional to on-board sensors, the vehicle may also acquire data from other devices or sensors in the area, for example, security cameras or other imaging sensors.

FIG. 10 illustrates exemplary vehicles 124 for providing location-based services or application using the systems and methods described herein as well as collecting data for such services or applications described herein. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively, or additionally, the one or more detectors or sensors may include an accelerometer built or embedded into or within the interior of the vehicle 124. The vehicle 124 may include one or more distance data detection device or sensor, such as a LiDAR device. The distance data detection sensor may include a laser range finder that rotates a mirror directing a laser to the surroundings or vicinity of the collection vehicle on a roadway or another collection device on any type of pathway.

A connected vehicle includes a communication device and an environment sensor array for reporting the surroundings of the vehicle 124 to the mapping system 121. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and the mapping system 121. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the lane marking indicators (lane marking type, lane marking intensity, lane marking color, lane marking offset, lane marking width, or other characteristics) received from geographic database 123 and the mapping system 121 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) received from geographic database 123 and the mapping system 121 and driving commands or navigation commands.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) received from geographic database 123 and the mapping system 121 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) received from geographic database 123 and the mapping system 121 and driving commands or navigation commands.

The term “computer-readable medium” includes a single medium or multiple medium, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for lane level origin destination analysis, the method comprising:
acquiring a plurality of probe data from a plurality of probe apparatuses traversing a roadway;
map matching each of the probe data to respective lanes of respective links using a lane level map matcher;
selecting first vehicle routes that traversed a first lane on a first link during a first time period;
determining first origins and first destinations for each of the first vehicle routes;
identifying a prevalence of the first origins and first destinations; and
generating a visualization of the prevalence of the first origins and first destinations.

2. The method of claim 1, wherein each probe apparatus of the plurality of probe apparatuses is traveling between a respective origin and destination pair, each probe apparatus comprising one or more sensors and being onboard a respective vehicle, wherein each probe data comprises location information associated with a respective probe apparatus.

3. The method of claim 1, further comprising:
selecting second vehicle routes that traversed a second lane on the first link during the first time period;
determining second origins and second destinations for each of the second vehicle routes;
identifying a prevalence of the second origins and second destinations;
comparing the prevalence of the first origins and destinations with the prevalence of the second origins and destinations; and
determining which of the first or second lane to close based on the comparison.

4. The method of claim 1, further comprising:
identifying locations that will be affected most by a closure of the first lane based on the prevalence of the first origins and first destinations.

5. The method of claim 1, further comprising:
providing advertisements to vehicles in the first lane based on either an expected origin or expected destination based on the prevalence of the first origins and first destinations.

6. The method of claim 1, further comprising:
predicting downstream traffic based on traffic volume of the first lane and the prevalence of the first origins and first destinations.

7. The method of claim 1, wherein determining first origins and first destinations comprises:
dividing the roadway into a plurality of clusters based on characteristics of the first origins and first destinations; and
identifying most popular origin and destination clusters that respective vehicles traversed both upstream and downstream from the first link.

8. The method of claim 7, wherein the plurality of clusters each comprise a quadkey.

9. The method of claim 1, further comprising
identifying one or more events occurring during the first time period;
wherein the one or more events affect the prevalence of the first origins and first destinations.

10. The method of claim 9, wherein the one or more events are recurring events.

11. A mapping system comprising:
a geographic database configured to store a plurality of probe data from a plurality of probe apparatuses traversing a roadway; and
a mapping server configured to:
map match each of the probe data to respective lanes of respective links using a lane level map matcher;
select first vehicle routes that traversed a first lane on a first link during a first time period;
determine first origins and first destinations for each of the first vehicle routes;
identify a prevalence of the first origins and first destinations; and
generate a visualization of the prevalence of the first origins and first destinations.

12. The mapping system of claim 11, wherein each probe apparatus of the plurality of probe apparatuses is traveling between a respective origin and destination pair, each probe apparatus comprising one or more sensors and being onboard a respective vehicle, wherein each probe data comprises location information associated with the respective probe apparatus.

13. The mapping system of claim 11, wherein the mapping server is further configured to:
select second vehicle routes that traversed a second lane on the first link during the first time period;
determine second origins and second destinations for each of the second vehicle routes;
identify a prevalence of the second origins and second destinations;
compare the prevalence of the first origins and destinations with the prevalence of the second origins and destinations; and
determine which of the first or second lane to close based on the comparison.

14. The mapping system of claim 11, wherein the mapping server is further configured to:
identify locations that will be affected most by a closure of the first lane based on the prevalence of the first origins and first destinations.

15. The mapping system of claim 11, wherein the mapping server is further configured to:
provide advertisements to vehicles in the first lane based on either an expected origin or expected destination based on the prevalence of the first origins and first destinations.

16. The mapping system of claim 11, wherein the mapping server is further configured to:
predict downstream traffic based on traffic volume of the first lane and the prevalence of the first origins and first destinations.

17. An apparatus comprising:
at least one processor; and
at least one memory including computer program code for one or more programs; the at least one memory configured to store the computer program code configured to, with the at least one processor, cause the at least one processor to:
acquire a plurality of probe data from a plurality of probe apparatuses traversing a roadway;
map match each of the probe data to respective lanes of respective links using a lane level map matcher;
select first vehicle routes that traversed a first lane on a first link during a first time period;
determine first origins and first destinations for each of the first vehicle routes;
identify a prevalence of the first origins and first destinations; and
generate a visualization of the prevalence of the first origins and first destinations.

18. The apparatus of claim 17, wherein each probe apparatus of the plurality of probe apparatuses is traveling between a respective origin and destination pair, each probe apparatus comprising one or more sensors and being onboard a respective vehicle, wherein each probe data comprises location information associated with the respective probe apparatus.

19. The apparatus of claim 17, wherein the computer program code is further configured to cause the at least one processor to:
select second vehicle routes that traversed a second lane on the first link during the first time period;
determine second origins and second destinations for each of the second vehicle routes;
identify a prevalence of the second origins and second destinations;
compare the prevalence of the first origins and destinations with the prevalence of the second origins and destinations; and
determine which of the first or second lane to close based on the comparison.

20. The apparatus of claim 17, wherein the computer program code is further configured to cause the at least one processor to:
identify locations that will be affected most by a closure of the first lane based on the prevalence of the first origins and first destinations.
